(19) United States
(12) Patent Application Publication
(10) Pub. No.: US 2024/0425728 A1
(43) Pub. Date: Dec. 26, 2024

(54) ADHESIVE FILM AND OPTICAL DISPLAY APPARATUS COMPRISING THE SAME

(71) Applicant: SAMSUNG SDI CO., LTD., Yongin-si (KR)

(72) Inventors: Do Young KIM, Suwon-si (KR); Sung Han KIM, Suwon-si (KR); Il Jin KIM, Suwon-si (KR)

(21) Appl. No.: 18/749,487

(22) Filed: Jun. 20, 2024

(30) Foreign Application Priority Data
Jun. 21, 2023 (KR) 10-2023-0080006

(51) Int. Cl. C09J 133/10; C09J 11/06

(52) U.S. Cl. CPC C09J 133/10; C09J 11/06

(57) ABSTRACT

An adhesive film and an optical display apparatus including the same are provided herein. The adhesive film includes: a (meth)acrylic copolymer; a chain-transfer agent; a photoinitiator; and a UV absorber mixture, wherein the UV absorber mixture includes: an indole-based UV absorber as a first UV absorber; and at least one of a triazine-based UV absorber or a benzotriazole-based UV absorber as a second UV absorber.

### CROSS-REFERENCE TO RELATED APPLICATION

The present application claims priority to and the benefit of Korean Patent Application No. 10-2023-0080006, filed on Jun. 21, 2023 in the Korean Intellectual Property Office, the entire content of which is incorporated herein by reference.

### BACKGROUND

### 1. Field

Embodiments of the present disclosure relate to an adhesive film and an optical display apparatus including the same.

### 2. Description of the Related Art

Recently, many attempts have been made to eliminate a polarizing plate from optical display apparatuses. This can achieve reduction in thickness of optical display apparatuses, reduction in manufacturing costs, and improvement in processability. Here, an adhesive film is used to replace the functions of a typical polarizing plate.

In an optical display apparatus not including a polarizer, an adhesive film formed on an upper surface of an organic light emitting diode (OLED) panel (for example, a surface of the OLED panel on which external light is incident) may be provided to protect against UV-induced damage to the organic light emitting diode. For additional information, see, e.g., Korean Patent Laid-open Publication No. 2007-0055363.

The adhesive film may be fabricated prior to being attached to the OLED panel by partially curing an adhesive film composition to a set or predetermined degree. The fabricated adhesive film may be post-cured after attachment to the OLED panel. The partially cured adhesive film has a relatively low storage modulus compared to a fully cured adhesive film. Thus, the partially cured adhesive film can be better attached to the OLED panel. Here, photocuring may be preferable for post-curing of the adhesive film because the adhesive film is post-cured on the OLED panel.

Therefore, there is a desire and/or need for an adhesive film that has appropriate or suitable ranges of storage modulus and peel strength both in a partially cured state and after post-curing while providing protection against UV-induced damage to organic light emitting diodes.

The above information disclosed in this Background section is only for enhancement of understanding of the background of the disclosure and therefore it may contain information that does not constitute prior art.

### SUMMARY

Aspects of one or more embodiments of the present disclosure are directed toward an adhesive film that is a partially cured film and secures appropriate or suitable ranges of storage modulus and peel strength both in a partially cured state and after post-curing while providing protection against UV-induced damage to organic light emitting diodes.

Aspects of one or more embodiments of the present disclosure are directed toward an adhesive film.

Aspects of one or more embodiments of the present disclosure are directed toward an optical display apparatus.

Additional aspects will be set forth in part in the description which follows and, in part, will be apparent from the description, or may be learned by practice of the presented embodiments of the disclosure.

One or more embodiments of the present disclosure include an adhesive film including: a (meth)acrylic copolymer; a chain-transfer agent; a photoinitiator; and a UV absorber mixture, wherein the UV absorber mixture includes: an indole-based UV absorber as a first UV absorber; and at least one of a triazine-based UV absorber (for example, 2-hydroxyphenyl-s-triazine) or a benzotriazole-based UV absorber (for example, 2-(5-chloro-2H-benzotriazol-2-yl)-6-(1,1-dimethylethyl)-4-methylphenol) as a second UV absorber.

According to one or more embodiments of the present disclosure, an optical display apparatus includes a cured product of the adhesive film.

Embodiments of the present disclosure provide an adhesive film that is a partially cured film and secures appropriate or suitable ranges of storage modulus and peel strength both in a partially cured state and after post-curing while providing protection against UV-induced damage to organic light emitting diodes.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Hereinafter, example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

The terminology used herein is for the purpose of describing particular embodiments only and is not intended to limit the present disclosure. As used herein, the singular forms ““a”,” ““an”,” and ““the”” are intended to include the plural forms as well, unless the context clearly indicates otherwise. It will be further understood that the terms “comprises,” “comprising,” “includes,” “including,” “have,” “having,” “contain,” and “containing,” when used in this specification, specify the presence of the stated features, integers, steps, operations, elements, and/or components, but do not preclude the presence or addition of one or more other features, integers, steps, operations, elements, components, and/or groups thereof.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “on,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the drawings. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, such as an area, layer, film, region or portion, is referred to as being “on” another element, it can be directly on the other element, or one or more intervening elements may be present. In addition, it will also be understood that when an element is referred to as being “between” two elements, it can be the only element between the two elements, or one or more intervening elements may also be present.

As used herein, the term “and/or” includes any and all combinations of one or more of the associated listed items. Unless otherwise apparent from the disclosure, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from among a, b, and c,” “at least one from among a, b, and c,” “one from among a, b, and c”, “at least one of a to c” indicates only a, only b, only c, both a and b, both a and c, both b and c, all of a, b, and c, or variations thereof.

As used herein, the terms “use,” “using,” and “used” may be considered synonymous with the terms “utilize,” “utilizing,” and “utilized,” respectively.

As used herein, “post-curing” is photocuring, wherein photocuring may include curing an adhesive film (for example, 100 μm to 200 μm thick) through irradiation with 315 nm to 400 nm UV light at a fluence of 1,000 mJ/cm² to 3,000 mJ/cm², for example, 2,000 mJ/cm² to 3,000 mJ/cm² using a metal halide lamp.

As used herein, “partial curing” is photocuring, wherein photocuring may include applying an adhesive film composition to a set or predetermined thickness on one surface of a release film and curing the adhesive film composition through irradiation with 315 nm to 400 nm UV light at a fluence of 300 mJ/cm² to 2,000 mJ/cm² using a black light (BL) lamp.

As used herein, “homopolymer glass transition temperature” may refer to a glass transition temperature (Tg) measured on a homopolymer of a target monomer using a differential scanning calorimeter (Discovery, TA Instruments, Inc.). For example, the homopolymer of the target monomer is heated to 180° C. at a heating rate of 20° C./min, cooled gradually to −100° C., and heated to 100° C. at a heating rate of 10° C./min to obtain data on an endothermic transition curve, followed by determining the glass transition temperature by an inflection point of the endothermic transition curve.

As used herein, “average particle diameter” of organic nanoparticles refers to a Z-average particle diameter of the organic nanoparticles obtained by measurement in an aqueous or organic solvent using a Zetasizer (Nano-ZS instrument, Malvern Instruments Ltd.) and an average particle diameter of the organic nanoparticles obtained by observation of SEM/TEM images. In the present disclosure, when particles are spherical, “diameter” indicates a particle diameter or an average particle diameter, and when the particles are non-spherical, the “diameter” indicates a major axis length or an average major axis length.

As used herein, “(meth)acryl” refers to acryl and/or methacryl.

As used herein, “index of refraction” is a value measured in the visible light spectrum, for example, at a wavelength of 550 nm.

As used herein, “light transmittance” refers to single transmittance.

As used herein, to represent a specific numerical range, the expression “X to Y” refers to “greater than or equal to X and less than or equal to Y (X≤ and ≤Y)”.

One aspect of the present disclosure relates to an optically clear adhesive (OCA) film.

In accordance with one aspect of the present disclosure, an adhesive film is provided. Herein, the adhesive film is a partially cured product of an adhesive film composition described in more detail below. As will be described in more detail below, if (e.g., when) the adhesive film is used in an optical display apparatus free from (e.g., not including) a polarizing plate, the adhesive film may be finally attached and secured to an adherend (for example, an optical display panel) through a process in which the adhesive film is attached to the optical display panel, followed by post-curing.

In one or more embodiments, “post-cured adhesive film” refers to an adhesive film having a storage modulus ratio of 100%, as calculated according to Equation 1.

The adhesive film refers to an adhesive film before post-curing and has a different storage modulus than the post-cured adhesive film, as measured at the same temperature. This leads to a determination that the adhesive film has a different degree of curing than the post-cured adhesive film.

In one or more embodiments, the adhesive film may have a storage modulus ratio of about 80% to less than about 100%, for example, about 80% to about 95%, as calculated according to Equation 1:

$$Storage modulus ratio = ( A / B ) \times 100 , \qquad Equation 1$$

In Equation 1, A is a storage modulus (unit: kPa) of the adhesive film, as measured at about 25° C., and B is a storage modulus (unit: kPa) of the post-cured adhesive film, as measured at about 25° C.

In one or more embodiments, the adhesive film may have a UV curing conversion of about 80% to less than about 100%, for example, about 90% to about 99%. The UV curing conversion may be measured as follows.

First, with respect to the adhesive film composition, intensities of absorption peaks near 1,635 cm⁻¹ (C═C) and 1,720 cm⁻¹ (C═O) are measured using an FT-IR spectrometer (NICOLET 4700, Thermo Electronics). Thereafter, the composition is applied to a glass substrate, followed by photocuring through irradiation with 315 nm to 400 nm UV light at a fluence of 1,000 mJ/cm² using a black light (BL) lamp, thereby obtaining an adhesive film specimen having a size of 20 cm×20 cm×3 μm (width×length×thickness). Thereafter, the obtained adhesive film specimen is divided into aliquots, followed by measurement of intensities of absorption peaks near 1635 cm⁻¹ (C═C) and 1720 cm⁻¹ (C═O) using an FT-IR spectrometer (NICOLET 4700, Thermo Electronics). The UV curing conversion is calculated according to Equation 2:

$$UV curing conversion ( \% ) = \vert 1 - ( C / D ) \vert \times 100 , \qquad Equation 2$$

In Equation 2, C is an intensity ratio of an absorption peak near 1635 cm⁻¹ to an absorption peak near 1720 cm⁻¹, as measured with respect to the adhesive film, and D is an intensity ratio of an absorption peak near 1635 cm⁻¹ to an absorption peak near 1720 cm⁻¹, as measured with respect to the adhesive film composition.

The adhesive film has an appropriate or suitable range of storage modulus and peel strength despite being in a partially cured state and thus can be reliably attached to an adherend.

In one or more embodiments, the adhesive film may have a storage modulus of about 150 kPa or less, for example, about 10 kPa, about 20 kPa, about 30 kPa, about 40 kPa, about 50 kPa, about 60 kPa, about 70 kPa, about 80 kPa, about 90 kPa, about 100 kPa, about 110 kPa, about 120 kPa, about 130 kPa, about 140 kPa, about 150 kPa, or about 10 kPa to about 150 kPa, as measured at about 25° C. Within these ranges, the adhesive film can have good or suitable flexural reliability due to good or suitable viscoelasticity after post-curing.

In one or more embodiments, the adhesive film may have a storage modulus of about 100 kPa or less, for example, about 10 kPa, about 20 kPa, about 30 kPa, about 40 kPa, about 50 kPa, about 60 kPa, about 70 kPa, about 80 kPa, about 90 kPa, about 100 kPa, or about 10 kPa to about 50 kPa, as measured at about 60° C. Within these ranges, the adhesive film can have good or suitable flexural reliability due to good or suitable viscoelasticity after post-curing.

In one or more embodiments, the adhesive film may have a peel strength of about 4,000 gf/inch or more, for example, about 4,000 gf/inch to about 6,000 gf/inch, as measured with respect to a glass plate. Within these ranges, the adhesive film can be less prone to peeling off of an optical display panel after post-curing, thereby providing good or suitable reliability.

The adhesive film has an appropriate or suitable range of storage modulus and peel strength after post-curing and thus can be reliably attached and secured to an adherend while providing good or suitable flexural reliability under repeated bending.

In one or more embodiments, the adhesive film may have a storage modulus of about 150 kPa or less, for example, about 10 kPa, about 20 kPa, about 30 kPa, about 40 kPa, about 50 kPa, about 60 kPa, about 70 kPa, about 80 kPa, about 90 kPa, about 100 kPa, or about 10 kPa to about 150 kPa, as measured at about 25° C. after post-curing. Within these ranges, the adhesive film can have good or suitable flexural reliability due to good or suitable viscoelasticity after post-curing.

In one or more embodiments, the adhesive film may have a storage modulus of about 50 kPa or less, for example, about 10 kPa to about 50 kPa, as measured at about 60° C. after post-curing. Within these ranges, the adhesive film can have good or suitable flexural reliability due to good or suitable viscoelasticity after post-curing.

In one or more embodiments, the adhesive film may have a peel strength of about 4,000 gf/inch or more, for example, about 4,000 gf/inch to about 6,000 gf/inch, as measured with respect to a glass plate after post-curing. Within these ranges, the adhesive film can be less prone to peeling off of an optical display panel after post-curing, thereby providing good or suitable reliability.

The adhesive film provides protection against UV-induced damage to organic light emitting diodes. In accordance with one or more embodiments of the present disclosure, the adhesive film may have a set or predetermined light transmittance in a set or predetermined wavelength region after post-curing, thereby providing protection against UV-induced damage to organic light emitting diodes. In one or more embodiments, the adhesive film may have a set or predetermined light transmittance in a set or predetermined wavelength region before post-curing, thereby providing protection against UV-induced damage to an organic light emitting element.

In one or more embodiments, the adhesive film may have a light transmittance of about 1% or less, for example, about 0% to less than about 1% or about 0.01% to about 0.5%, as measured at a wavelength of about 380 nm. Within these ranges, the adhesive film can provide protection against UV-induced damage to organic light emitting diodes.

In one or more embodiments, the adhesive film may have a light transmittance of about 3% or less, for example, about 0% to less than about 3%, or about 0.01% to about 2.5%, as measured at a wavelength of about 405 nm. Within these ranges, the adhesive film can provide protection against UV-induced damage to an organic light emitting element.

Here, the above values of “light transmittance at a wavelength of about 380 nm” and “light transmittance at a wavelength of about 405 nm” are values measured with respect to both the adhesive film and the post-cured adhesive film.

In one or more embodiments, the adhesive film may have a light transmittance of about 70% or more, for example, about 70% to about 85% or about 75% to about 80%, as measured at a wavelength of about 430 nm. Within these ranges, the adhesive film can be used as an optically clear adhesive film in an optical display apparatus.

Here, the above values of “light transmittance at a wavelength of about 430 nm” are values measured with respect to both the adhesive film and the post-cured adhesive film.

The adhesive film may be formed by partially curing an adhesive film composition described in more detail below through irradiation with UV light. In order to ensure that the adhesive film has light transmittance in the above ranges at wavelengths of about 380 nm and about 405 nm, respectively, the adhesive film composition may include the following specific UV absorbers: an indole-based UV absorber as a first UV absorber; and at least one of a triazine-based UV absorber, for example, 2-hydroxyphenyl-s-triazine; and/or a benzotriazole-based UV absorber, for example, 2-(5-chloro-2H-benzotriazol-2-yl)-6-(1,1-dimethylethyl)-4-methylphenol, as a second UV absorber. In general, a UV absorber serves to reduce the degree of curing by absorbing UV light during photocuring.

The adhesive film may include the first UV absorber and the second UV absorber.

The first UV absorber and the second UV absorber allow partial curing of the adhesive film composition including a (meth)acrylic copolymer described in more detail below, thereby ensuring that an adhesive film formed of the adhesive film composition has a storage modulus and peel strength in the above ranges.

When the adhesive film includes the second UV absorber along with the first UV absorber, the adhesive film can have significantly lower light transmittance at wavelengths of 380 nm and 405 nm, as compared to if (e.g., when) the adhesive film is free from (e.g., does not include) the second UV absorber and includes the same amount of the first UV absorber.

Moreover, if (e.g., when) the adhesive film includes the second UV absorber along with the first UV absorber, the adhesive film can have significantly lower light transmittance at wavelengths of 380 nm and 405 nm, as compared to if (e.g., when) the adhesive film includes a different type or kind of UV absorber instead of the second UV absorber while including the same amount of the first UV absorber.

If the adhesive film contains a different type or kind of UV absorber instead of the second UV absorber despite including the first UV absorber, the adhesive film can be less effective in providing protection against UV-induced damage to organic light emitting diodes due to reduction in UV absorption performance while causing deterioration in reflective color quality due to reduction in color uniformity.

According to one or more embodiments of the present disclosure, the adhesive film may be formed of an adhesive film composition including a (meth)acrylic copolymer, a chain-transfer agent, and a photoinitiator described in more detail below, thereby providing the desired or suitable benefits set forth herein. In the following, an adhesive film according to one or more embodiments of the present disclosure will be described.

The adhesive film may include a (meth)acrylic copolymer, a chain-transfer agent, a photoinitiator, and a UV absorber mixture, wherein the UV absorber mixture includes: an indole-based UV absorber as a first UV absorber; and at least one of a triazine-based UV absorber, for example, 2-hydroxyphenyl-s-triazine; and/or a benzotriazole-based UV absorber, for example, 2-(5-chloro-2H-benzotriazol-2-yl)-6-(1,1-dimethylethyl)-4-methylphenol, as a second UV absorber.

The (meth)acrylic copolymer may be a copolymer of a monomer mixture including an alkyl group-containing (meth)acrylic monomer and a hydroxyl group-containing (meth)acrylic monomer.

The alkyl group-containing (meth)acrylic monomer may form a matrix of the adhesive film. The alkyl group-containing (meth)acrylic monomer may be an unsubstituted linear or branched C₁ to C₂ alkyl group-containing (meth)acrylate. For example, the alkyl group-containing (meth)acrylic monomer may include at least one of 2-ethylhexyl (meth)acrylate, n-butyl (meth)acrylate, isooctyl (meth)acrylate, propyl (meth)acrylate, t-butyl (meth)acrylate, isobutyl (meth)acrylate, pentyl (meth)acrylate, hexyl (meth)acrylate, heptyl (meth)acrylate, octyl (meth)acrylate, nonyl (meth)acrylate, or decyl (meth)acrylate, for example, at least one of 2-ethylhexyl (meth)acrylate, n-butyl (meth)acrylate, or isooctyl (meth)acrylate, or for example, 2-ethylhexyl acrylate or n-butyl acrylate.

The alkyl group-containing (meth)acrylic monomer may have a homopolymer glass transition temperature of about −20° C. or less, for example, about −80° C. to about −20° C., or about −80° C. to about −40° C. Within these ranges, the adhesive film can have improved foldability under low temperature conditions and under high temperature and high humidity conditions.

The alkyl group-containing (meth)acrylic monomer may be present in an amount of about 10% by weight (wt %) to about 90 wt % for example, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt %, about 85 wt %, about 86 wt %, about 87 wt %, about 88 wt %, about 89 wt %, about 90 wt %, or about 20 wt % to about 60 wt %, for example, about 25 wt % to about 55 wt %, or about 30 wt % to about 50 wt %, relative to 100 wt % of the monomer mixture. Within these ranges, the adhesive film can have improved foldability under low temperature conditions and under high temperature and high humidity conditions.

The hydroxyl group-containing (meth)acrylic monomer serves to improve peel strength of the adhesive film.

The hydroxyl group-containing (meth)acrylic monomer may be a linear or branched C₁ to C₁₀ (meth)acrylate containing at least one hydroxyl group. For example, the hydroxyl group-containing (meth)acrylic monomer may include at least one of 2-hydroxybutyl (meth)acrylate, 4-hydroxybutyl (meth)acrylate, 2-hydroxyethyl (meth)acrylate, 2-hydroxypropyl (meth)acrylate, 3-hydroxypropyl (meth)acrylate, or 6-hydroxyhexyl (meth)acrylate, without being limited thereto.

The hydroxyl group-containing (meth)acrylic monomer may have a homopolymer glass transition temperature of about 0° C. or less, for example, about −70° C. to about 0° C., about −60° C. to about −10° C., or about −50° C. to about −10° C. Within these ranges, the adhesive film can have improved peel strength and foldability.

The hydroxyl group-containing (meth)acrylic monomer may be present in an amount of about 0.1 wt % to about 30 wt %, for example, about 0.1 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 1 wt % to about 30 wt %, about 5 wt % to about 25 wt %, or about 10 wt % to about 25 wt %, relative to 100 wt % of the monomer mixture. Within these ranges, the adhesive film can have further improved peel strength and durability.

The monomer mixture may further include a (meth)acrylic or vinyl monomer having a high homopolymer glass transition temperature.

The (meth)acrylic or vinyl monomer having a high homopolymer glass transition temperature serves to improve peel strength of the adhesive film or enhance cohesion of the adhesive film composition.

In one or more embodiments, the (meth)acrylic or vinyl monomer may have a higher homopolymer glass transition temperature than each of the alkyl group-containing (meth)acrylic monomer and the hydroxyl group-containing (meth)acrylic monomer. In this way, it is possible to ensure that the storage modulus of the adhesive film can easily reach the ranges described above while allowing the adhesive film to have improved peel strength, as compared to if (e.g., when) the monomer mixture only includes the alkyl group-containing (meth)acrylic monomer and the hydroxyl group-containing (meth)acrylic monomer, which have low homopolymer glass transition temperatures.

For example, the (meth)acrylic or vinyl monomer may have a homopolymer glass transition temperature of about 5° C. or more, for example, about 5° C., about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 125° C., about 130° C., about 135° C., about 140° C., about 145° C., about 150° C., about 155° C., about 160° C., about 165° C., about 170° C., about 175° C., about 180° C., about 185° C., about 190° C., about 195° C., about 200° C., about 5° C. to about 200° C., or about 10° C. to about 200° C. Within these ranges, the adhesive film can have improved peel strength.

The type or kind of (meth)acrylic or vinyl monomer having a high homopolymer glass transition temperature is not particularly limited, so long as the (meth)acrylic or vinyl monomer has a homopolymer glass transition temperature in the ranges described above.

In one or more embodiments, the (meth)acrylic or vinyl monomer may be a nitrogen-containing (meth)acrylic or vinyl monomer to facilitate dilution of the UV absorbers described in more detail below. Because the adhesive film may be formed of a solvent-free adhesive film composition, the UV absorbers in the adhesive film composition need to be well diluted to avoid increase in haze of the adhesive film. The solvent-free adhesive film composition may provide an adhesive film having a homogeneous surface if (e.g., when) photocured.

In one or more embodiments, the (meth)acrylic or vinyl monomer may include at least one of a hetero-cycloaliphatic group-containing (meth)acrylic or hetero-cycloaliphatic group-containing vinyl monomer; or a cycloaliphatic group-containing (meth)acrylic or cycloaliphatic group-containing vinyl monomer to maximize or increase dispersion of the UV absorbers in the adhesive film composition and to improve peel strength of the adhesive film.

In one or more embodiments, the (meth)acrylic or vinyl monomer may be a mixture of a hetero-cycloaliphatic group-containing (meth)acrylic or hetero-cycloaliphatic group-containing vinyl monomer and a cycloaliphatic group-containing (meth)acrylic or cycloaliphatic group-containing vinyl monomer.

The hetero-cycloaliphatic group-containing (meth)acrylic or hetero-cycloaliphatic group-containing vinyl monomer may be (meth)acryloylmorpholine, N-vinyl pyrrolidone, and/or the like.

The hetero-cycloaliphatic group-containing (meth)acrylic or hetero-cycloaliphatic group-containing vinyl monomer may be present in an amount of about 0.1 wt % to about 30 wt %, for example, about 0.1 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 1 wt % to about 20 wt %, about 5 wt % to about 20 wt %, or about 5 wt % to about 15 wt %, relative to 100 wt % of the monomer mixture. Within these ranges, the adhesive film can have further improved peel strength and durability.

The cycloaliphatic group-containing (meth)acrylic or cycloaliphatic group-containing vinyl monomer may be dihydrodicyclopentadienyl (meth)acrylate (for example, dihydrodicyclopentadienyl acrylate (DCPA)), isobornyl (meth)acrylate, and/or the like.

The cycloaliphatic group-containing (meth)acrylic or vinyl monomer may be present in an amount of about 0.1 wt % to about 30 wt %, for example, about 0.1 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 1 wt % to about 20 wt %, about 5 wt % to about 20 wt %, or about 5 wt % to about 15 wt %, relative to 100 wt % of the monomer mixture. Within these ranges, the adhesive film can have further improved peel strength and durability.

The (meth)acrylic or vinyl monomer having a high homopolymer glass transition temperature may be present in an amount of about 0 wt % to about 70 wt %, for example, about 0 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, or about 10 wt % to about 50 wt %, relative to 100 wt % of the monomer mixture. Within these ranges, the adhesive film can have improved adhesion.

In one or more embodiments, the alkyl group-containing (meth)acrylic monomer, the hydroxyl group-containing (meth)acrylic monomer, and the (meth)acrylic or vinyl group monomer having a high homopolymer glass transition temperature may be present, in total, in an amount of about 80 wt % or more, for example, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt %, about 99 wt %, about 100 wt %, or about 80 wt % to about 100 wt %, relative to 100 wt % of the monomer mixture. Within these ranges, the adhesive film can easily provide the desired or suitable benefits set forth herein.

The monomer mixture may further include an aromatic group-containing (meth)acrylic monomer.

The aromatic group-containing (meth)acrylic monomer serves to reduce the dielectric constant of the adhesive film before and after post-curing or to adjust the index of refraction of the adhesive film.

The aromatic group-containing (meth)acrylic monomer may be a substituted or unsubstituted C₆ to C₂₀ aryl group-containing (meth)acrylic monomer or a substituted or unsubstituted C₇ to C₂₀ arylalkyl group-containing (meth)acrylic monomer, such as benzyl (meth)acrylate, phenyl (meth)acrylate, naphthyl (meth)acrylate, phenoxy (meth)acrylate, and benzyl phenyl (meth)acrylate.

The aromatic group-containing (meth)acrylic monomer may be present in an amount of about 70 wt % or less, for example, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, about 70 wt % wt %, or about 10 wt % to about 40 wt %, relative to 100 wt % of the monomer mixture. Within these ranges, the aromatic group-containing (meth)acrylic monomer can aid in reducing the dielectric constant of the adhesive film or adjusting the index of refraction of the adhesive film.

In one or more embodiments, the alkyl group-containing (meth)acrylic monomer, the hydroxyl group-containing (meth)acrylic monomer, the (meth)acrylic or vinyl monomer having a high homopolymer glass transition temperature, and the aromatic group-containing (meth)acrylic monomer may be present, in total, in an amount of about 95 wt % or more, for example, about 95 wt % to about 100 wt %, in the monomer mixture. Within these ranges, the adhesive film can easily provide the desired or suitable benefits set forth herein.

The (meth)acrylic copolymer may be prepared from the monomer mixture described above by a typical polymerization method generally available, generally utilized, and/or suitable in the art.

The chain-transfer agent serves to increase fluidity of the (meth)acrylic copolymer through adjustment of the weight average molecular weight of the (meth)acrylic copolymer. The chain-transfer agent may include at least one of a monofunctional or polyfunctional primary or secondary thiol compound, a thioglycolic acid-based compound, a thiocarbonyl compound, or mercaptopropionic acid-based compound.

For example, the chain-transfer agent may include β-mercaptopropionic acid, 2-ethylhexyl-3-mercaptopropionate, n-octyl-3-mercaptopropionate, methoxybutyl-3-mercaptopropionate, stearyl-3-mercaptopropionate, trimethylolpropane tris(3-mercaptopropionate), tris-[(3-mercaptopropionyloxy)-ethyl]-isocyanurate, pentaerythritol tetrakis(3-mercaptopropionate), tetraethylene glycol bis(3-mercaptopropionate), dipentaerythritol hexakis(3-mercaptopropionate), 3,3′-thiodipropionic acid, dithiopropionic acid, laurylthiopropionic acid, thioglycolic acid, ammonium thioglycolate, monoethanolamine thioglycolate, diammonium thioglycolate, and/or the like.

The chain-transfer agent may be present in an amount of about 0.01 parts by weight to about 2 parts by weight, for example, about 0.01 parts by weight, about 0.05 parts by weight, about 0.1 parts by weight, about 0.2 parts by weight, about 0.3 parts by weight, about 0.4 parts by weight, about 0.5 parts by weight, about 0.6 parts by weight, about 0.7 parts by weight, about 0.8 parts by weight, about 0.9 parts by weight, about 1 parts by weight, about 1.1 parts by weight, about 1.2 parts by weight, about 1.3 parts by weight, about 1.4 parts by weight, about 1.5 parts by weight, about 1.6 parts by weight, about 1.7 parts by weight, about 1.8 parts by weight, about 1.9 parts by weight, about 2 parts by weight, about 0.1 parts by weight to about 1 part by weight, about 0.1 parts by weight to about 0.5 parts by weight, or about 0.1 parts by weight to about 0.3 parts by weight, relative to 100 parts by weight of the (meth)acrylic copolymer in the adhesive film composition or relative to 100 parts by weight of a cured product of the (meth)acrylic copolymer in the adhesive film, in terms of solid content (e.g., amount). Within these ranges, the chain-transfer agent can improve fluidity of the (meth)acrylic copolymer through adjustment of the weight average molecular weight of the (meth)acrylic copolymer without reduction and/or with a limited reduction in transparency of the adhesive film due to an excess of the chain-transfer agent.

As used herein, “cured product of the (meth)acrylic copolymer” refers to a product obtained by partially curing the (meth)acrylic copolymer using the photoinitiator.

The chain-transfer agent may be present in an amount of about 0.01 wt % to about 2 wt %, for example, about 0.01 wt % to about 0.5 wt %, relative to 100 wt % of the adhesive film. Within these ranges, the chain-transfer agent can improve fluidity of the (meth)acrylic copolymer through adjustment of the weight average molecular weight of the (meth)acrylic copolymer without reduction and/or with a limited reduction in transparency of the adhesive film due to an excess of the chain-transfer agent.

The photoinitiator serves to cure the adhesive film composition into an adhesive film and to post-cure the adhesive film. In one or more embodiments, the photoinitiator includes a photo-radical initiator.

The type or kind of photoinitiator is not particularly limited so long as the photoinitiator can cure the adhesive film composition upon irradiation with UV light.

For example, the photoinitiator may be a benzoin photoinitiator, a hydroxy ketone photoinitiator, an aminoketone photoinitiator, or a phosphine oxide photoinitiator.

The photoinitiator may be present in an amount of about 0.1 parts by weight to about 2 parts by weight, for example, about 0.1 parts by weight to about 1 part by weight or about 0.3 parts by weight to about 0.6 parts by weight, relative to 100 parts by weight of the (meth)acrylic copolymer in the adhesive film composition, in terms of solid content (e.g., amount). Within these ranges, the photoinitiator can facilitate curing of the adhesive film into an adhesive film and post-curing of the adhesive film.

The photoinitiator may be present in an amount of about 0.01 wt % to about 5 wt %, for example, about 0.01 wt % to about 1 wt %, or about 0.2 wt % to about 0.6 wt %, relative to 100 wt % of the adhesive film. Within these ranges, the photoinitiator can facilitate curing of the adhesive film composition into an adhesive film and post-curing of the adhesive film.

The adhesive film may include an indole-based UV absorber as the first UV absorber.

The indole-based UV absorber serves to reduce light transmittance of the adhesive film at a wavelength of about 380 nm or about 405 nm. Thus, if (e.g., when) used in an optical display apparatus, the adhesive film can provide protection against UV-induced damage to organic light emitting diodes.

The indole-based UV absorber may have a maximum absorption wavelength of about 390 nm or greater, about 390 nm to about 400 nm, or, for example, greater than about 390 nm to less than about 400 nm. Within these ranges, the adhesive film can sufficiently absorb light at a wavelength of about 420 nm or less, light at a wavelength of about 400 nm to about 420 nm, and/or light at a wavelength of about 405 nm or less, among external light incident on the adhesive film, thereby reducing UV transmittance and thus reducing UV-induced damage to organic light emitting diodes. Here. “maximum absorption wavelength” refers to a wavelength at which a maximum absorption peak appears, that is, a wavelength corresponding to a maximum absorbance in an absorbance curve as a function of wavelength. Here, “absorbance” may be measured by any typical method generally available, generally utilized and/or suitable in the art.

The Indole-based UV absorber may include a compound represented by Formula 1:

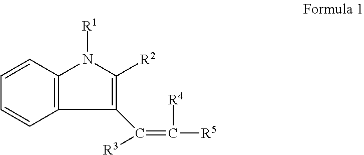

In Formula 1, R¹ is hydrogen or a substituted or unsubstituted C₁ to C₁₀ alkyl group, R² is hydrogen or a substituted or unsubstituted C₆ to C₂₀ aryl group, R³ is hydrogen or a substituted or unsubstituted C₁ to C₁₀ alkyl group, R⁴ is hydrogen, a cyano group (CN), or a substituted or unsubstituted C₁ to C₁₀ alkyl group, and R⁵ is a cyano group or —(C═O)O—R⁶ (R⁶ being a substituted or unsubstituted C₁ to C₁₀ alkyl group or a substituted or unsubstituted C₆ to C₂₀ aryl group).

For example, R¹ may be a C₁ to C₅ alkyl group, for example, a methyl group, R² may be a C₆ to C₁₀ aryl group, for example, a phenyl group, R³ may be hydrogen or a C₁ to C₅ alkyl group, for example, hydrogen, R⁴ may be a cyano group, and R⁵ may be a cyano group or ═(C═O)—O—R⁶ (R⁶ being a substituted or unsubstituted C₁ to C₅ alkyl group).

For example, the indole-based UV absorber may include a compound represented by Formula 1-1 or Formula 1-2:

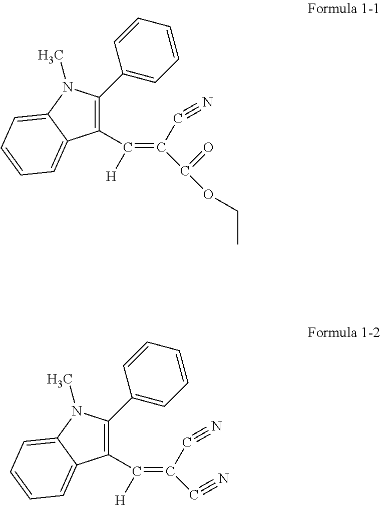 [SMILES: CCOC(=O)/C(C#N)=C/c1c(-c2ccccc2)n(C)c2ccccc12 ; Cn1c(-c2ccccc2)c(C=C(C#N)C#N)c2ccccc21]

In one or more embodiments, the indole-based UV absorber may have a melting point of about 100° C. or more, for example, about 140° C. to about 220° C., and may be in a solid phase at room temperature.

The indole-based UV absorber may be present in an amount of about 0.01 parts by weight to about 0.5 parts by weight, about 0.01 parts by weight, about 0.05 parts by weight, about 0.06 parts by weight, about 0.07 parts by weight, about 0.08 parts by weight, about 0.09 parts by weight, about 0.1 parts by weight, about 0.2 parts by weight, about 0.3 parts by weight, about 0.4 parts by weight, about 0.5 parts by weight, about 0.6 parts by weight, about 0.7 parts by weight, about 0.8 parts by weight, about 0.9 parts by weight, about 1 parts by weight, about 1.1 parts by weight, about 1.2 parts by weight, about 1.3 parts by weight, about 1.4 parts by weight, about 1.5 parts by weight, about 1.6 parts by weight, about 1.7 parts by weight, about 1.8 parts by weight, about 1.9 parts by weight, about 2 parts by weight, about 2.1 parts by weight, about 2.2 parts by weight, about 2.3 parts by weight, about 2.4 parts by weight, about 2.5 parts by weight, about 2.6 parts by weight, about 2.7 parts by weight, about 2.8 parts by weight, about 2.9 parts by weight, about 3 parts by weight, about 3.1 parts by weight, about 3.2 parts by weight, about 3.3 parts by weight, about 3.4 parts by weight, about 3.5 parts by weight, about 3.6 parts by weight, about 3.7 parts by weight, about 3.8 parts by weight, about 3.9 parts by weight, about 4 parts by weight, about 4.1 parts by weight, about 4.2 parts by weight, about 4.3 parts by weight, about 4.4 parts by weight, about 4.5 parts by weight, about 4.6 parts by weight, about 4.7 parts by weight, about 4.8 parts by weight, about 4.9 parts by weight, about 5 parts by weight, for example, about 0.05 parts by weight to about 0.5 parts by weight, or about 0.05 parts by weight to about 0.3 parts by weight, relative to 100 parts by weight of the (meth)acrylic copolymer in the adhesive film composition or relative to 100 parts by weight of the cured product of the (meth)acrylic copolymer in the adhesive film, in terms of solid content (e.g., amount). Within these ranges, the indole-based UV absorber can aid in providing protection against UV-induced damage to organic light emitting diodes without reduction and/or with a limited reduction in UV curing conversion upon irradiation with UV light.

The indole-based UV absorber may be present in an amount of about 0.01 wt % to about 10 wt %, for example, about 0.01 wt % to about 5 wt %, or about 0.01 wt % to about 3 wt %, relative to 100 wt % of the adhesive film. Within these ranges, the indole UV absorber can aid in providing protection against UV-induced damage to organic light emitting diodes without reduction and/or with a limited reduction in UV curing conversion during photocuring.

The adhesive film includes at least one of a triazine-based UV absorber, for example, 2-hydroxyphenyl-s-triazine; and/or a benzotriazole-based UV absorber, for example, 2-(5-chloro-2H-benzotriazol-2-yl)-6-(1,1-dimethylethyl)-4-methylphenol, as the second UV absorber. The second UV absorber provides protection against UV-induced damage to organic light emitting diodes through absorption of UV light, ensures that the storage modulus and peel strength of the adhesive film reach (easily reach) the ranges described above during partial curing of the adhesive film composition, and significantly reduces light transmittance of the adhesive film at wavelengths of about 380 nm and about 405 nm in combination with the first UV absorber.

In one or more embodiments, the triazine-based UV absorber may be a compound represented by Formula 2:

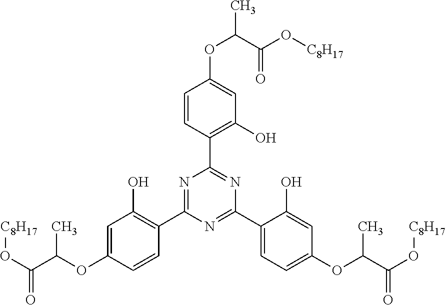

The triazine-based UV absorber may be prepared by a method generally available, generally utilized, and/or suitable in the art, or may be a commercially available product, such as Tinuvin 477.

The benzotriazole-based UV absorber may be a compound represented by Formula 3:

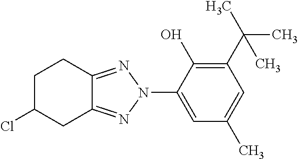 [SMILES: Cc1cc(-n2nc3c(n2)CC(Cl)CC3)c(O)c(C(C)(C)C)c1]

The benzotriazole-based UV absorber may be prepared by a method generally available to, generally utilized by, and/or suitable to those skilled in the art, or may be a commercially available product, such as Tinuvin 326.

The second UV absorber may be present in an amount of about 0.01 parts by weight to about 5 parts by weight, for example, about 0.01 parts by weight, about 0.05 parts by weight, about 0.06 parts by weight, about 0.07 parts by weight, about 0.08 parts by weight, about 0.09 parts by weight, about 0.1 parts by weight, about 0.2 parts by weight, about 0.3 parts by weight, about 0.4 parts by weight, about 0.5 parts by weight, about 0.6 parts by weight, about 0.7 parts by weight, about 0.8 parts by weight, about 0.9 parts by weight, about 1 parts by weight, about 1.1 parts by weight, about 1.2 parts by weight, about 1.3 parts by weight, about 1.4 parts by weight, about 1.5 parts by weight, about 1.6 parts by weight, about 1.7 parts by weight, about 1.8 parts by weight, about 1.9 parts by weight, about 2 parts by weight, about 2.1 parts by weight, about 2.2 parts by weight, about 2.3 parts by weight, about 2.4 parts by weight, about 2.5 parts by weight, about 2.6 parts by weight, about 2.7 parts by weight, about 2.8 parts by weight, about 2.9 parts by weight, about 3 parts by weight, about 3.1 parts by weight, about 3.2 parts by weight, about 3.3 parts by weight, about 3.4 parts by weight, about 3.5 parts by weight, about 3.6 parts by weight, about 3.7 parts by weight, about 3.8 parts by weight, about 3.9 parts by weight, about 4 parts by weight, about 4.1 parts by weight, about 4.2 parts by weight, about 4.3 parts by weight, about 4.4 parts by weight, about 4.5 parts by weight, about 4.6 parts by weight, about 4.7 parts by weight, about 4.8 parts by weight, about 4.9 parts by weight, about 5 parts by weight, about 0.1 parts by weight to about 5 parts by weight, relative to 100 parts by weight of the (meth)acrylic copolymer in the adhesive film composition or relative to 100 parts by weight of the cured product of the (meth)acrylic copolymer, in terms of solid content (e.g., amount). Within these ranges, the second UV absorber can provide protection against UV-induced damage to organic light emitting diodes through absorption of UV light.

The second UV absorber may be present in an amount of about 0.01 wt % to about 5 wt %, for example, about 0.05 wt % to about 5 wt % or about 0.1 wt % to about 5 wt %, relative to 100 wt % of the adhesive film. Within these ranges, the second UV absorber can provide protection against UV-induced damage to organic light emitting diodes through absorption of UV light.

In order to ensure both absorption of UV light by the second UV absorber and partial curing of the adhesive film composition through UV-initiated photocuring reaction, a weight ratio of the photoinitiator to the second UV absorber in the adhesive film or the adhesive film composition, as calculated according to Equation 3, is adjusted to a range of about 0.06 to about 6, for example about 0.06, about 0.1, about 0.5, about 1, about 1.5, about 2, about 2.5, about 3, about 3.5, about 4, about 4.5, about 5, about 5.5, about 6, or, for example, about 0.1 to about 3. Within these ranges, it is possible to ensure that UV-initiated photocuring reaction takes place while ensuring that the second UV absorber provides protection against UV-induced damage to organic light emitting diodes through absorption of UV light.

$$Weight ratio = photoinitiator / second UV absorber , \qquad Equation 3$$

The first UV absorber and the second UV absorber may be present, in total, in an amount of about 95 wt % or more, for example, about 95 wt % to about 100 wt %, based on the total weight (100 wt %) of all UV absorbers contained in the adhesive film. Within these ranges, the adhesive film can provide the desired or suitable benefits described herein without an increase and/or with a reduced increase in haze due to an excess of the UV absorbers. Here, among all the UV absorbers, a UV absorber other than the first UV absorber and the second UV absorber may be any typical absorber generally available, generally utilized, and/or suitable in the art to absorb light in the UV spectrum.

The first UV absorber and the second UV absorber may be present in a weight ratio of about 1:0.5 to about 1:90, for example, about 1:0.5 to about 1:85 (the first UV absorber: the second UV absorber), in the adhesive film. Within these ranges, the UV absorbers can provide (easily provide) the desired or suitable benefits described herein.

The adhesive film may further include a crosslinking agent.

The crosslinking agent serves to increase the degree of crosslinking of the adhesive film composition, thereby improving mechanical strength of the adhesive film.

The crosslinking agent may include an actinic radiation-curable polyfunctional (meth)acrylate. For example, the crosslinking agent may include: bifunctional (meth)acrylates, such as 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecane dimethanol (meth)acrylate, dimethylol dicyclopentane di(meth)acrylate, ethylene oxide-modified hexahydrophthalic acid di(meth)acrylate, tricyclodecane dimethanol (meth)acrylate, neopentyl glycol-modified trimethylpropane di(meth)acrylate, adamantane di(meth)acrylate, or 9,9-bis[4-(2-acryloyloxyethoxy)phenyl]fluorene; trifunctional (meth)acrylates, such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylate, or tris(meth)acryloxyethyl isocyanurate; tetrafunctional (meth)acrylates, such as diglycerin tetra(meth)acrylate or pentaerythritol tetra(meth)acrylate; pentafunctional (meth)acrylates, such as dipentaerythritol penta(meth)acrylate; and/or hexafunctional (meth)acrylates, such as dipentaerythritol hexa(meth)acrylate, caprolactone-modified dipentaerythritol hexa(meth)acrylate, caprolactone-modified urethane (meth)acrylate, or a reaction product of an isocyanate monomer and trimethylolpropane tri(meth)acrylate, without being limited thereto.

The crosslinking agent may be present in an amount of about 5 parts by weight or less, for example, about 0.01 parts by weight to about 1 part by weight, relative to 100 parts by weight of the (meth)acrylic copolymer in the adhesive film composition or relative to 100 parts by weight of the cured product of the (meth)acrylic copolymer, in terms of solid content (e.g., amount). Within these ranges, the crosslinking agent can improve mechanical strength of the adhesive film without affecting and/or with a limited effect on other properties of the adhesive film.

The adhesive film may further include a silane coupling agent.

The silane coupling agent serves to further enhance peel strength of the adhesive film with respect to an adherend. The silane coupling agent may include any typical silane coupling agent generally available, generally utilized and/or suitable in the art. For example, the silane coupling agent may include at least one selected from among (e.g., selected from the group consisting of): a silicon compound having an epoxy structure, such as 3-glycidoxypropyltrimethoxysilane, 3-glycidoxypropylmethyldimethoxysilane, and 2-(3,4-epoxycyclohexyl)ethyltrimethoxysilane; a polymerizable unsaturated group-containing silicon compound, such as vinyltrimethoxysilane, vinyltriethoxysilane, and (meth)acryloxypropyltrimethoxysilane; an amino group-containing silicon compound, such as, 3-aminopropyltrimethoxysilane, N-(2-aminoethyl)-3-aminopropyltrimethoxysilane, and N-(2-aminoethyl)-3-aminopropylmethyldimethoxysilane; and 3-chloropropyltrimethoxysilane, without being limited thereto.

The silane coupling agent may be present in an amount of about 5 parts by weight or less, for example, about 0.1 parts by weight to about 3 parts by weight, relative to 100 parts by weight of the (meth)acrylic copolymer in the adhesive film composition or relative to 100 parts by weight of the cured product of the (meth)acrylic copolymer, in terms of solid content (e.g., amount). Within these ranges, the silane coupling agent can improve adhesion of the adhesive film to an adherend without affecting and/or with a limited effect on other properties of the adhesive film.

The silane coupling agent may be present in an amount of about 0 wt % to about 5 wt %, or, for example, about 0.1 wt % to about 3 wt %, relative to 100 wt % of the adhesive film. Within these ranges, the silane coupling agent can improve adhesion of the adhesive film to an adherend without affecting and/or with a limited effect on other properties of the adhesive film.

The adhesive film may include typical additives, such as an antistatic agent, a surfactant, a curing accelerator, an ionic liquid, a lithium salt, inorganic fillers, a softener, a molecular weight modifier, an antioxidant, an anti-aging agent, a stabilizer, an adhesion-imparting resin, a modified resin (for example, a polyol resin, a phenolic resin, an acrylic resin, a polyester resin, a polyolefin resin, an epoxy resin, an epoxidized polybutadiene resin, and/or the like), a leveling agent, a defoamer, a plasticizer, a dye, a pigment (a coloring pigment, an extender pigment, and/or the like), a treatment agent, a fluorescent brightener, a dispersant, a heat stabilizer, a light stabilizer, a flocculant, and/or a lubricant.

The additives may be present in an amount of about 10 wt % or less, for example, about 0.01 wt % to about 10 wt %, for example, about 0.01 wt % to about 1 wt %, relative to 100 wt % of the adhesive film. Within these ranges, the additives can provide intended effects without affecting and/or with a limited effect on adhesion and reliability of the adhesive film.

The adhesive film may have a thickness of about 200 μm or less, for example, greater than about 0 μm to about 200 μm, or about 150 μm to about 200 μm. Within these ranges, the adhesive film can be used in an optical display apparatus.

The adhesive film may be fabricated by coating the adhesive film composition onto one surface of a base film to form a coating layer, followed by drying and photocuring of the coating layer. A release film may be further attached to one surface of the adhesive film to prevent or reduce foreign matter from adhering to the adhesive film after aging of the coating layer. The coating layer may be dried through heat treatment at a temperature of about 100° C. to about 150° C. for about 0.5 to about 5 minutes. Drying of the coating layer may not be provided if not necessary and/or desired. In one or more embodiments, photocuring may be partial curing. For example, if (e.g., when) there is a need to control the fluence of UV radiation such that the adhesive film has a UV curing conversion of less than 100%, as calculated according to Equation 2, then the adhesive film may not be fully cured.

Next, an adhesive film according to one or more embodiments of the present disclosure will be described.

The adhesive film may include a (meth)acrylic copolymer, a chain-transfer agent, a photoinitiator, a UV absorber mixture, and organic nanoparticles, wherein the UV absorber mixture includes: an indole-based UV absorber as a first UV absorber; and at least one of a triazine-based UV absorber, for example, 2-hydroxyphenyl-s-triazine, and/or a benzotriazole-based UV absorber, for example, 2-(5-chloro-2H-benzotriazol-2-yl)-6-(1,1-dimethylethyl)-4-methylphenol, as a second UV absorber.

The adhesive film is substantially the same as the adhesive film described above except that the adhesive film further includes organic nanoparticles. Addition of the organic nanoparticles should not affect the properties of the adhesive films described above. The organic nanoparticles serve to improve impact resistance of the adhesive film.

The organic nanoparticles can improve impact resistance of an OLED panel free from (e.g., not including) a polarizing plate on an upper surface thereof.

The organic nanoparticles may have an average particle diameter of about 10 nm to about 400 nm, about 10 nm to about 300 nm, about 30 nm to about 280 nm, or, for example, about 50 nm to about 280 nm. Within these ranges, the adhesive film can have good or suitable transparency (a total luminous transmittance of 90% or greater in the visible spectrum) while retaining foldability.

The organic nanoparticles may have an index of refraction of about 1.35 to about 1.70, for example, about 1.40 to about 1.60. Within these ranges, the adhesive film can have good or suitable transparency.

The organic nanoparticles may include core-shell-type or kind nanoparticles or simple nanoparticles such as bead-type or kind nanoparticles, without being limited thereto. When the organic nanoparticles include core-shell-type or kind nanoparticles, the core and shell of each of the organic nanoparticles may satisfy Equation 4. For example, both the core and shell of each of the organic nanoparticles may be formed of an organic material. This core-shell particle morphology ensures good or suitable foldability of the adhesive film and good or suitable balance between elasticity and flexibility of the adhesive layer.

$$Tg ( c ) < Tg ( s ) , \qquad Equation 4$$

In Equation 4, Tg(c) is a glass transition temperature (unit: ° C.) of the core, and Tg(s) is a glass transition temperature (unit: ° C.) of the shell.

As used herein, “shell” refers to an outermost layer of each of the organic nanoparticles. The core of each of the organic nanoparticles may be a single spherical (or substantially spherical) particle. However, the core may further include an additional layer around (e.g., surrounding) the spherical particle, so long as Equation 4 is satisfied.

For example, the core may have a glass transition temperature of about −150° C. to about 10° C., about −150° C. to about −5° C., or, for example, about −150° C. to about −20° C. Within these ranges, the adhesive film can have viscoelasticity at low temperatures and/or at room temperature. The core may include at least one of poly(alkyl acrylate), polysiloxane, or polybutadiene having a glass transition temperature in the above ranges.

The poly(alkyl acrylate) may include at least one of poly(methyl acrylate), poly(ethyl acrylate), poly(propyl acrylate), poly(butyl acrylate), poly(isopropyl acrylate), poly(hexyl acrylate), poly(hexyl methacrylate), poly(ethylhexyl acrylate), poly(ethylhexyl methacrylate), or polysiloxane, without being limited thereto.

The polysiloxane may be, for example, an organosiloxane (co)polymer. The organosiloxane (co)polymer may be crosslinked or uncrosslinked. The crosslinked organosiloxane (co)polymer may be used to ensure impact resistance and colorability of the adhesive film. Here, crosslinked organosiloxane may include crosslinked dimethylsiloxane, crosslinked methylphenylsiloxane, crosslinked diphenylsiloxane, and/or a (e.g., any suitable) mixture thereof. When a copolymer of two or more organosiloxanes is used as the core, the index of refraction of the organic nanoparticles can be adjusted to a range of about 1.41 to about 1.50.

The degree of crosslinking of the organosiloxane (co)polymer may be determined based on the degree to which the organosiloxane (co)polymer is soluble in one or more suitable organic solvents. As the degree of crosslinking of the organosiloxane (co)polymer increases, the organosiloxane (co)polymer becomes less soluble in a solvent. Solvents such as acetone or toluene may be used to determine the degree of crosslinking of the organosiloxane (co)polymer. For example, the organosiloxane (co)polymer may have a portion that is insoluble in acetone or toluene. For example, the content (e.g., amount) of a toluene-insoluble component in the organosiloxane (co)polymer may be 30% or more.

The organosiloxane (co)polymer may further include a crosslinked alkyl acrylate polymer. The crosslinked alkyl acrylate polymer may be methyl acrylate, ethyl acrylate, n-butyl acrylate, 2-ethylhexyl acrylate, and/or the like. For example, the crosslinked alkyl acrylate polymer may be n-butyl acrylate or 2-ethylhexyl acrylate having a low glass transition temperature.

For example, the shell may have a glass transition temperature of about 15° C. to about 150° C., about 35° C. to about 150° C., or, for example, about 50° C. to about 140° C. Within these ranges, the organic nanoparticles can have good or suitable dispersibility in the (meth)acrylic copolymer. The shell may include a poly(alkyl methacrylate) having a glass transition temperature in the above ranges. For example, the shell may include at least one of poly(methyl methacrylate) (PMMA), poly(ethyl methacrylate), poly(propyl methacrylate), poly(butyl methacrylate), poly(isopropyl methacrylate), poly(isobutyl methacrylate), or poly(cyclohexyl methacrylate), without being limited thereto.

The core may be present in an amount of about 30 wt % to about 99 wt %, about 40 wt % to about 95 wt %, or, for example, about 50 wt % to about 90 wt %, relative to 100 wt % of the organic nanoparticles. Within these ranges, the adhesive film can have good or suitable foldability over a wide temperature range. The shell may be present in an amount of about 1 wt % to about 70 wt %, about 5 wt % to about 60 wt %, for example, about 10 wt % to about 50 wt %, relative to 100 wt % of the organic nanoparticles. Within these ranges, the adhesive film can have good or suitable foldability over a wide temperature range.

The organic nanoparticles may be present in an amount of about 10 parts by weight or less, for example, about 0.1 parts by weight to about 9 parts by weight, relative to 100 parts by weight of the (meth)acrylic copolymer in the adhesive film composition or relative to 100 parts by weight of the cured product of the (meth)acrylic copolymer, in terms of solid content (e.g., amount). Within these ranges, the adhesive film can have improved impact resistance without an increase and/or with a reduced increase in haze due to an excess of the organic nanoparticles.

The organic nanoparticles may be present in an amount of about 0.1 wt % to about 20 wt %, about 0.5 wt % to about 10 wt %, or about 0.5 wt % to about 8 wt %, relative to 100 wt % of the adhesive film. Within these ranges, the adhesive film can have improved impact resistance without an increase and/or with a reduced increase in haze due to an excess of the organic nanoparticles.

The organic nanoparticles may be fabricated by any typical method generally available, generally utilized and/or suitable in the art, such as emulsion polymerization, suspension polymerization, and/or solution polymerization.

Next, an optical display apparatus according to one or more embodiments of the present disclosure will be described.

The optical display apparatus includes the adhesive film according to one or more embodiments of the present disclosure. In one or more embodiments, the optical display apparatus includes an LED panel and an adhesive film attached to a light exit surface of the LED panel, wherein the adhesive film may be a post-cured product of the adhesive film according to one or more embodiments of the present disclosure. The post-cured product of the adhesive film has a light transmittance in the above ranges, as measured at a wavelength of about 380 or about 405 nm, a storage modulus in the above ranges, as measured at a temperature of about 25° C. to about 60° C., and a peel strength in above ranges, as measured at with respect to a glass plate. Thus, the post-cured product of the adhesive film can replace a polarizing plate, thereby allowing the optical display apparatus to be free from (e.g., not include) the polarizing plate.

Next, embodiments of the present disclosure will be described in more detail with reference to some examples. However, it should be noted that these examples are provided for illustration only and are not to be construed in any way as limiting the present disclosure.

### Example 1

In Example 1, 100 parts by weight of a monomer mixture including 40 parts by weight of 2-ethylhexyl acrylate, 20 parts by weight of 4-hydroxybutyl acrylate, 10 parts by weight of acryloylmorpholine, 10 parts by weight of dihydrodicyclopentadienyl acrylate (DCPA), and 20 parts by weight of benzyl acrylate were placed in a reactor, followed by addition of toluene as a solvent. Thereafter, a photoinitiator was added, followed by polymerization of the monomer mixture through stirring for 30 minutes under nitrogen purging, thereby obtaining a (meth)acrylic copolymer derived from 2-ethylhexyl acrylate, 4-hydroxybutyl acrylate, acryloylmorpholine, dihydrodicyclopentadienyl acrylate, and benzyl acrylate.

In terms of solid content (e.g., amount), 100 parts by weight of the obtained (meth)acrylic copolymer was mixed with 0.06 parts by weight of a crosslinking agent, 0.3 parts by weight of a photoinitiator, 0.13 parts by weight of an indole-based UV absorber, 0.10 parts by weight of Tinuvin 477 (BASF Chemicals Co., ltd.), 0.15 parts by weight of a chain-transfer agent, and 0.10 parts by weight of a silane coupling agent, thereby preparing an adhesive film composition.

The prepared adhesive film composition was applied at a thickness of 200 μm to one surface of a polyethylene terephthalate film (not coated with a release agent, thickness; 75 μm, TU73A, SKC Co., ltd.) as a release film, followed by irradiation with 315 nm to 400 nm UV light at a fluence of 1,000 mJ/cm² using a black light (BL) lamp, thereby fabricating an adhesive film (partially cured, UV curing conversion according to Equation 2: 95%, thickness: 200 μm) attached to the one surface of the release film.

### Examples 2 to 6

y Adhesive films were fabricated in substantially the same manner as in Example 1 except that the kind and/or content (e.g., amount) of each component were changed as listed in Table 1.

### Comparative Examples 1 to 4

Adhesive films were fabricated in substantially the same manner as in Example 1 except that the kind and/or content (e.g., amount) of each component were changed as listed in Table 1.

TABLE 1

| | | Cross- | | Chain- | Silane | | UV absorber | | | | | | |
|---|---|---|---|---|---|---|---|---|---|---|---|---|---|
| | Copol- | linking | Photo- | transfer | coupling | Organic | UA- | Tinuvin- | Tinuvin- | Tinuvin- | Tinuvin- | Tinuvin- | Equa- |
| | ymer | agent | initiator | agent | agent | particle | 3912 | 477 | 326 | 479 | 460 | 384-2 | tion 3 |
| Example 1 | 100 | 0.06 | 0.3 | 0.15 | 0.10 | 0 | 0.13 | 0.10 | 0 | 0 | 0 | 0 | 3 |
| Example 2 | 100 | 0.06 | 0.6 | 0.15 | 0.10 | 0 | 0.06 | 5.00 | 0 | 0 | 0 | 0 | 0.12 |
| Example 3 | 100 | 0.06 | 0.3 | 0.15 | 0.10 | 0 | 0.13 | 0 | 0.5 | 0 | 0 | 0 | 0.6 |
| Example 4 | 100 | 0.06 | 0.3 | 0.15 | 0.10 | 1 | 0.13 | 0.10 | 0 | 0 | 0 | 0 | 3 |
| Example 5 | 100 | 0.06 | 0.3 | 0.15 | 0.10 | 5 | 0.13 | 0.10 | 0 | 0 | 0 | 0 | 3 |
| Example 6 | 100 | 0.06 | 0.3 | 0.15 | 0.10 | 7 | 0.13 | 0.10 | 0 | 0 | 0 | 0 | 3 |
| Comparative | 100 | 0.06 | 0.3 | 0.15 | 0.10 | 0 | 0.13 | 0 | 0 | 0 | 0 | 0 | — |
| Example 1 | | | | | | | | | | | | | |
| Comparative | 100 | 0.06 | 0.3 | 0.15 | 0.10 | 0 | 0.13 | 0 | 0 | 0.10 | 0 | 0 | 3 |
| Example 2 | | | | | | | | | | | | | |
| Comparative | 100 | 0.06 | 0.3 | 0.15 | 0.10 | 0 | 0.13 | 0 | 0 | 0 | 0.10 | 0 | 3 |
| Example 3 | | | | | | | | | | | | | |
| Comparative | 100 | 0.06 | 0.3 | 0.15 | 0.10 | 0 | 0.13 | 0 | 0 | 0 | 0 | 0.10 | 3 |
| Example 4 | | | | | | | | | | | | | |

* In Table 1,

Crosslinking agent: Hexanediol diacrylate,

Photoinitiator: TPO (BASF Chemicals Co., ltd.),

Chain-transfer agent: 2-ethylhexyl-3-mercaptopropionate (EHMP, TCI Co., ltd.),

Silane coupling agent: KBM-403 (Shin-Etsu Chemical Co., ltd.),

Organic particles: Core-shell-type or kind organic nanoparticles manufactured by emulsion polymerization (core: poly(butyl acrylate), shell: poly(methyl methacrylate), shell content (e.g., amount): 35 wt %, core content (e.g., amount): 65 wt %, average particle diameter (D50): 100 nm, index of refraction: 1.48),

UA-3912 (Orient Chemical Industries co., ltd.): Indole based UV absorber,

Tinuvin 477 (BASF Chemicals Co., ltd.): Triazine based UV absorber,

Tinuvin 326 (BASF Chemicals Co., ltd.): Benzotriazole based UV absorber,

Tinuvin 479 (BASF Chemicals Co., ltd.): Triazine based UV absorber (having different chemical structure than Tinuvin 477),

Tinuvin 460 (BASF Chemicals Co., ltd.): Triazine based UV absorber (having different chemical structure than Tinuvin 477),

Tinuvin 384-2 (BASF Chemicals Co., ltd.): Benzotriazole based UV absorber (having different chemical structure than Tinuvin 326), and

Equation 3: (Content (in wt %) of the photoinitiator in the adhesive film)/(Total content (e.g., amount) (in wt %) of the triazine-based UV absorber and the benzotriazole-based UV absorber in the adhesive film)(weight ratio)

Each of the adhesive films fabricated in Examples 1 to 6 and Comparative Examples 1 to 4 was evaluated as to the following properties. Results are shown in Table 2.

(1) Storage Modulus (Unit: kPa)

Storage modulus was measured in auto-strain mode under conditions of axial force: 1.0 N, sensitivity: 0.1 N, frequency: 1.0 Hz, and strain: 1.0% using a dynamic viscoelasticity measuring instrument (DHR-3, TA Instruments Inc.). Specifically, an adhesive film stack having a thickness of 800 μm was prepared, followed by perforating the adhesive film stack using a perforator with a diameter of 8 mm, thereby preparing a circular specimen. Storage modulus of the specimen was measured at a heating rate of 5° C./min from −60° C. to 90° C., thereby obtaining storage modulus values of the adhesive film at 25° C. and 60° C.

(2) Peel Strength with Respect to Glass Plate (Unit: Gf/Inch)

Peel strength with respect to an alkali-free glass plate was measured. After a plasma-treated PET film (NK-P50DP) was attached to one surface of each of the adhesive films fabricated in Examples 1 to 6 and Comparative Examples 1 to 4, the adhesive film was cut to a size of 2.5 cm×10 cm (width×length). After a PET release film was removed from the adhesive film, the adhesive film was bonded to an alkali-free glass plate (soda-lime glass plate), thereby preparing a specimen in which the alkali-free glass plate, the adhesive film, and the plasma-treated PET film were stacked in this order. The prepared specimen was secured to a texture analyzer (TA) instrument, followed by measurement of peel strength of a stack of the adhesive film and the PET film with respect to the alkali-free glass plate under conditions of a temperature of 25° C., a peeling rate of 300 mm/min, and a peeling angle of 180°.

### (3) Light Transmittance (Unit: %) and Transmittance b*

First, light transmittance of an alkali-free glass plate was measured using a V650 spectrometer (JASCO Inc.) to determine a baseline. After a release film was removed from the adhesive film, the adhesive film was attached to the alkali-free glass plate, thereby preparing a specimen for measurement of light transmittance. Light transmittance was measured on the prepared specimen using a V650 spectrometer (JASCO Inc.). Transmittance b* value was also measured in substantially the same manner as in measurement of light transmittance.

### (4) Impact Resistance (Unit: Cm)

After the adhesive film with a release film removed therefrom was attached to one surface of an OLED panel (including an organic light emitting layer interposed between two substrates), a PET film (thickness: 50 μm, SH86, SKC Co., ltd.) was attached to the other surface of the adhesive film, followed by measurement of a minimum height from which dropping a BIG pen resulted in an indentation on the PET film and/or damage to the PET film.

TABLE 2

| | Storage | | | | | | | |
|---|---|---|---|---|---|---|---|---|
| | modulus | | | Light transmittance | | | | |
| | @25° | @60° | Peel | @380 | @405 | @430 | Transmittance | Impact |
| | C. | C. | strength | nm | nm | nm | b* | resistance |
| Example 1 | 98 | 36 | 5232 | 0.4 | 2.1 | 76.4 | 6.2 | 4 |
| Example 2 | 96 | 37 | 4965 | 0.04 | 2.4 | 77.2 | 5.8 | 4 |
| Example 3 | 92 | 36 | 5131 | 0.4 | 2.5 | 78.0 | 6.3 | 4 |
| Example 4 | 98 | 38 | 5233 | 0.4 | 2.1 | 75.5 | 6.2 | 4.5 |
| Example 5 | 100 | 39 | 5268 | 0.4 | 2.3 | 75.7 | 6.2 | 5 |
| Example 6 | 102 | 41 | 5312 | 0.4 | 2.4 | 75.7 | 6.2 | 6 |
| Comparative | 132 | 43 | 5531 | 5.3 | 8.5 | 81.2 | 6.2 | 3 |
| Example 1 | | | | | | | | |
| Comparative | 102 | 38 | 4985 | 3.6 | 8.0 | 80.0 | 6.0 | 3 |
| Example 2 | | | | | | | | |
| Comparative | 109 | 37 | 4685 | 1.8 | 8.4 | 81.4 | 6.1 | 3 |
| Example 3 | | | | | | | | |
| Comparative | 112 | 39 | 4876 | 3.5 | 5.7 | 74.5 | 6.3 | 3 |
| Example 4 | | | | | | | | |

Each of the adhesive films fabricated in Examples 1 to 6 and Comparative Examples 1 to 4 was irradiated with 315 nm to 400 nm UV light at a fluence of 1000 mJ/cm² using a metal halide lamp, thereby fabricating a post-cured adhesive film (fully cured, UV curing conversion according to Equation 2: 100%, thickness: 200 pam). The post-cured adhesive film was evaluated to the properties in substantially the same manner as above. Results are shown in Table 3.

TABLE 3

| | Storage | | | | | | | | |
|---|---|---|---|---|---|---|---|---|---|
| | modulus | | | Light transmittance | | | | | |
| | @25° | @60° | Peel | @380 | @405 | @430 | Transmittance | Impact | Equation |
| | C. | C. | strength | nm | nm | nm | b* | resistance | 1 |
| Example 1 | 115 | 37 | 5494 | 0.4 | 2.1 | 76.4 | 6.4 | 4 | 85 |
| Example 2 | 107 | 39 | 5184 | 0.04 | 2.4 | 77.2 | 5.9 | 4 | 90 |
| Example 3 | 102 | 37 | 5285 | 0.4 | 2.5 | 78.0 | 6.4 | 4 | 90 |
| Example 4 | 105 | 40 | 5285 | 0.4 | 2.1 | 75.5 | 6.4 | 4.55 | 93 |
| Example 5 | 108 | 40 | 5294 | 0.4 | 2.3 | 75.7 | 6.4 | 5 | 93 |
| Example 6 | 110 | 42 | 5432 | 0.4 | 2.4 | 75.7 | 6.4 | 6 | 93 |
| Comparative | 147 | 44 | 5642 | 5.3 | 8.5 | 81.2 | 6.1 | 3 | 90 |
| Example 1 | | | | | | | | | |
| Comparative | 113 | 39 | 5135 | 3.6 | 8.0 | 80.0 | 6.2 | 3 | 90 |
| Example 2 | | | | | | | | | |
| Comparative | 121 | 38 | 4732 | 1.8 | 8.4 | 81.4 | 6.3 | 3 | 90 |
| Example 3 | | | | | | | | | |
| Comparative | 124 | 40 | 4900 | 3.5 | 5.7 | 74.5 | 6.4 | 3 | 90 |
| Example 4 | | | | | | | | | |

As can be seen from Table 2 and Table 3, the adhesive film according to embodiments of the present disclosure had light transmittances of 1% or less and 3% or less at wavelengths 380 nm and 405 nm, respectively. In addition, the adhesive film according to embodiments of the present disclosure had light transmittances of 1% or less and 3% or less at wavelengths 380 nm and 405 nm, respectively, after post-curing and thus are expected to be able to provide protection against UV-induced damage to organic light emitting diodes. In addition, despite being in a partially cured state, the adhesive film according to embodiments of the present disclosure could be attached to an adherend with high reliability by satisfying the storage modulus and peel strength ranges described herein and could exhibit good or suitable flexural reliability due to good or suitable viscoelasticity after post-curing.

Conversely, the adhesive films of Comparative Examples failed to provide the desired or suitable benefits described herein.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Further, the use of “may” when describing embodiments of the present disclosure refers to “one or more embodiments of the present disclosure.”

A light emitting device, electronic apparatus or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. It is to be understood that the foregoing is an illustration of various example embodiments and is not to be construed as limited to the specific embodiments disclosed herein, and that various modifications, changes, and/or alterations to the disclosed embodiments, as well as other example embodiments, are intended to be included within the spirit and scope of the present disclosure as defined in the appended claims, and their equivalents.

What is claimed is:

1. An adhesive film comprising:
a (meth)acrylic copolymer;
a chain-transfer agent;
a photoinitiator; and
a UV absorber mixture,
wherein the UV absorber mixture comprises:
an indole-based UV absorber as a first UV absorber; and
at least one of a triazine-based UV absorber or a benzotriazole-based UV absorber as a second UV absorber.

2. The adhesive film as claimed in claim 1, wherein the adhesive film has a storage modulus ratio of 80% to less than 100%, as calculated according to Equation 1:
$$Storage modulus ratio = ( A / B ) \times 100 , \qquad Equation 1$$
wherein, in Equation 1, A is a storage modulus (unit: kPa) of the adhesive film, as measured at 25° C., and
B is a storage modulus (unit: kPa) of the adhesive film, as measured at 25° C. after post-curing.

3. The adhesive film as claimed in claim 1, wherein the adhesive film has a light transmittance of about 1% or less at a wavelength of 380 nm.

4. The adhesive film as claimed in claim 1, wherein the adhesive film has a light transmittance of about 3% or less at a wavelength of 405 nm.

5. The adhesive film as claimed in claim 1, wherein the adhesive film has a storage modulus of about 150 kPa or less at 25° C. and a storage modulus of about 100 kPa or less at 60° C.

6. The adhesive film as claimed in claim 1, wherein the indole-based UV absorber comprises a compound represented by Formula 1: 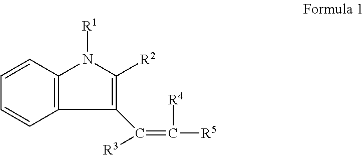
wherein R¹ is hydrogen or a substituted or unsubstituted C₁ to C₁₀ alkyl group,
R² is hydrogen or a substituted or unsubstituted C₆ to C₂₀ aryl group,
R³ is hydrogen or a substituted or unsubstituted C₁ to C₁₀ alkyl group,
R⁴ is hydrogen, a cyano group (CN), or a substituted or unsubstituted C₁ to C₁₀ alkyl group, and
R⁵ is a cyano group or —(C═O)O—R⁶ (R⁶ being a substituted or unsubstituted C₁ to C₁₀ alkyl group or a substituted or unsubstituted C₆ to C₂₀ aryl group).

7. The adhesive film as claimed in claim 1, wherein the indole-based UV absorber is in an amount of about 0.01 wt % to about 10 wt % relative to 100 wt % of the adhesive film.

8. The adhesive film as claimed in claim 1, wherein the second UV absorber is in an amount of about 0.01 wt % to about 5 wt % relative to 100 wt % of the adhesive film.

9. The adhesive film as claimed in claim 1, wherein the photoinitiator and the second UV absorber have in a weight ratio of about 0.06 to about 6 in the adhesive film, as calculated according to Equation 3:
$$Weight ratio = photoinitiator / second UV absorber . \qquad Equation 3$$

10. The adhesive film as claimed in claim 1, wherein a total of the first UV absorber and the second UV absorber together are in an amount of 95 wt % or more relative to 100 wt % of the UV absorber mixture.

11. The adhesive film as claimed in claim 1, wherein the (meth)acrylic copolymer is a copolymer of a monomer mixture comprising an alkyl group-containing (meth)acrylic monomer, a hydroxyl group-containing (meth)acrylic monomer, and a (meth)acrylic or vinyl monomer having a high homopolymer glass transition temperature.

12. The adhesive film as claimed in claim 11, wherein the (meth)acrylic or vinyl monomer having a high homopolymer glass transition temperature has a higher homopolymer glass transition temperature than each of the alkyl group-containing (meth)acrylic monomer and the hydroxyl group-containing (meth)acrylic monomer.

13. The adhesive film as claimed in claim 11, wherein the (meth)acrylic or vinyl monomer having a high homopolymer glass transition temperature comprises at least one of a nitrogen-containing (meth)acrylic or vinyl monomer or a cycloaliphatic group-containing (meth)acrylic or vinyl monomer.

14. The adhesive film as claimed in claim 11, wherein the (meth)acrylic or vinyl monomer having a high homopolymer glass transition temperature comprises at least one of (meth)acryloylmorpholine, N-vinyl pyrrolidone, dihydrodicyclopentadienyl acrylate, or isobornyl (meth)acrylate.

15. The adhesive film as claimed in claim 11, wherein the monomer mixture further comprises an aromatic group-containing (meth)acrylic monomer.

16. The adhesive film as claimed in claim 1, comprising:
about 100 parts by weight of the (meth)acrylic copolymer;
about 0.01 parts by weight to about 2 parts by weight of the chain-transfer agent, relative to 100 parts by weight of the (meth)acrylic copolymer;
about 0.1 parts by weight to about 2 parts by weight of the photoinitiator, relative to 100 parts by weight of the (meth)acrylic copolymer;
about 0.01 parts by weight to about 0.5 parts by weight of the first UV absorber, relative to 100 parts by weight of the (meth)acrylic copolymer; and
about 0.01 parts by weight to about 5 parts by weight of the second UV absorber, relative to 100 parts by weight of the (meth)acrylic copolymer.

17. The adhesive film as claimed in claim 1, further comprising organic nanoparticles.

18. The adhesive film as claimed in claim 17, wherein the organic nanoparticles are of a core-shell type and satisfy Equation 4:
$$Tg ( c ) < Tg ( s ) , \qquad Equation 4$$
wherein, in Equation 4, Tg(c) is a glass transition temperature (unit: ° C.) of a core, and Tg(s) is a glass transition temperature (unit: ° C.) of a shell.

19. The adhesive film as claimed in claim 1, further comprising at least one of a crosslinking agent or a silane coupling agent.

20. An optical display apparatus comprising a post-cured product of the adhesive film as claimed in claim 1.

21. The optical display apparatus as claimed in claim 20, wherein the optical display apparatus does not comprise a polarizing plate.

22. The adhesive film as claimed in claim 1, wherein the second UV absorber is the triazine-based UV absorber and comprises 2-hydroxyphenyl-s-triazine.

23. The adhesive film as claimed in claim 1, wherein the second UV absorber is the benzotriazole-based UV absorber and comprises 2-(5-chloro-2H-benzotriazol-2-yl)-6-(1,1-dimethylethyl)-4-methylphenol.
